(19) United States
(12) Patent Application Publication
(10) Pub. No.: US 2004/0172344 A1
(43) Pub. Date: Sep. 2, 2004

(54) Method and apparatus for automatic replenishment of goods to customer locations

(76) Inventors: Zachariah Stockwell, Capitola, CA (US); Bryce Shaur-hwa Yang, San Jose, CA (US)

Correspondence Address: MCDERMOTT, WILL & EMERY, 600 13th Street, N.W., Washington, DC, 20005-3096, US

(21) Appl. No.: 10/720,698

(22) Filed: Nov. 25, 2003

Related U.S. Application Data
(60) Provisional application No. 60/429,076, filed on Nov. 25, 2002.

(51) Int. Cl. G06F 17/60

(52) U.S. Cl. 705/28

(57) ABSTRACT

A method and system for distributing factory finished goods to customer locations in a volume-based fair share mode prioritizes requests for parts from inventory, and also prioritizes customer locations that have needs for these parts. A shipment plan is formed by iteratively: assigning a defined minimum size allotment of the parts to the location assigned the current highest priority, and re-assigning the priorities of the locations. This is done until all of the requested parts from inventory have been assigned or no location needs more of the parts assigned.

### RELATED APPLICATIONS

The present invention claims priority to Provisional Application 60/429,076, filed on Nov. 25, 2002, the entire disclosure of which is hereby incorporated by reference.

### FIELD OF THE INVENTION

The present invention relates generally to automatic replenishment of finished goods, and more particularly, to distributing factory finished goods or other parts to customer locations in a volume-based fair share mode.

### BACKGROUND OF THE INVENTION

During the course of business, customers need to be replenished with finished goods from a manufacturer. Such finished goods may be used by the customers to form part of a product or used for other purposes. For example, a computer manufacturer may need to be supplied with many different finished goods, such as hard disk drives, motherboards, etc. The replenishment scheduling and distribution of these goods may be critical to the manufacturer.

The term “Kanban” means “visible signal” in Japanese. Kanban signals are essentially demand signals from a customer, both external to and internal within the manufacturing of the business process using them. The Kanban demand signals authorize the beginning of work and, in effect, control the level of work in process and lead time per products. The use of these visible signals facilitates immediate feedback and abnormalities in the process to be addressed by immediate intervention activities or process improvement efforts. The application of Kanban to improve workflow in both manufacturing and office environment has become more commonplace. Kanban and just-in-time (JIT) manufacturing methods gained international awareness as Japanese manufacturers gained significant market shares for certain products. Various flow manufacturing and lean enterprise methods formalize improvement processes in manufacturing best practices.

Conventional methods of replenishing finished goods are determined based on anticipated build, or are determined based on the instructions that were based on anticipated build. In either case, the output of the finished goods does not always match the plan. This causes confusion, rework and delays in the shipment.

In distributing goods to various customer locations, it is desirable to provide a methodology for making shipping decisions in a rational manner. However, employing a manual decision making process allows reactive decisions to be made that can be based on geographical locations, time zones, lack of information, etc. Further, a manual process can lead to performing shipper cutting on a reduced frequency with greater quantities cut in order to produce a time savings as well as to keep from missing shipping quantities or delays in shipping from a business standpoint. This causes an increased workload for the shipping department who must consistently respond to problems with invalid shippers (such as no inventory, product on hold, etc.), causes the decision making to be based on a third party (as opposed to the manufacturer), and compromises the ability to enforce lot sizing rules, the ability to handle normally manual rules such as specific lot quantities, special instructions, etc.

### SUMMARY OF THE INVENTION

There is a need for automating the shipping process in order to provide a proper distribution of factory finished goods to customer locations in a volume-based fair share mode.

This and other needs are met by embodiments of the present invention that provide a computer-implemented method for distributing parts to customer locations in a volume-based fair share mode. The method comprises the steps of prioritizing requests for parts from inventory and prioritizing locations that have needs for the parts. A shipment plan is formed by iteratively: assigning a defined minimum size allotment of the parts to the location having the current highest priority; and re-assigning the priorities of the locations. These steps are performed until all of the parts from inventory have been assigned or no location needs more of the parts assigned.

The earlier stated needs are also met by embodiments of the present invention which provide a computer readable medium bearing programming instructions, which, when executed by a computer, cause the computer to determine distribution of parts from inventory to customer locations in a volume-based fair share mode. The medium causes the computer to perform the steps of prioritizing requests for a part from inventory by the customer locations based on the part, a priority need for the part, and inventory available to ship. Customer locations that have a need for the part are prioritized. A shipment plan is formed by iteratively assigning a defined minimum size allotment of the parts to the customer location having a current highest priority, and re-assigning the priorities of the customer locations.

The earlier stated needs are also met by a still further aspect of the present invention which provides a system for determining distribution of goods to customer locations and comprises a processor that receives requests for parts to be delivered to customer locations, and means for forming a shipment plan of the goods to the customer locations on a volume-based fair share basis.

The foregoing and other features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram depicting customer locations and sources of finished goods and a shipping arrangement constructed in accordance with embodiments of the present invention to perform an auto shipping method.

FIG. 2 is a flow diagram of the method of forming a shipping distribution in accordance with embodiments of the present invention.

### DETAILED DESCRIPTION OF THE INVENTION

The present invention addresses and solves problems related to the fair distribution of finished goods between a plurality of customer locations having a demand for those finished goods. The problems of providing a fair distribution is solved, in part, by providing for a computer-implementing method of distributing the parts to the customer locations in a volume-based fair share mode. The system and method prioritizes the requests for the parts and prioritizes those locations that have need for the parts. A shipment plan is formed by iteratively assigning a defined minimum size allotment of the parts to the location having a current highest priority. The priorities of the locations are then re-assigned. The steps are performed until all of the requested parts from inventory have been assigned or no location needs more of the parts assigned. In certain embodiments of the invention, following the formation of a shipment plan, the system and method perform a lot sizing optimization. The method and system allow for a single source auto ship processing, as well as multiple-source auto ship processing. The details of the system and method are provided below.

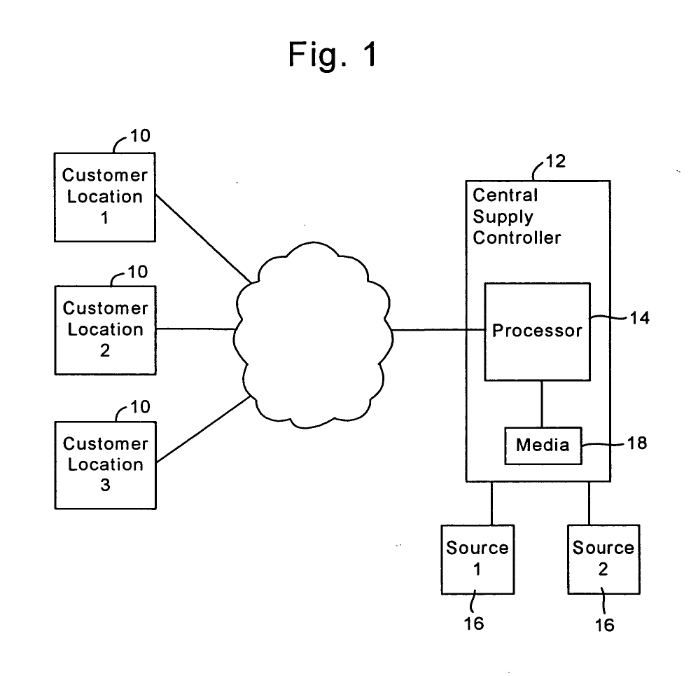

FIG. 1 is a block diagram depicting the customer locations and sources of finished goods, as well as an exemplary processor to perform the methods of the present invention.

In FIG. 1, a plurality of customer locations 10 are provided. These customer locations 10 may be geographically disparate, and even be located in different countries or continents. The customers may form part of a single organization or company, or be different companies. A central shipping controller 12 is provided at the manufacturer and includes a processor 14 that performs the methodology of the present invention, described in more detail below. A plurality of sources 16 of finished goods or parts communicate with the processor 14 of the central shipping controller 12. The communications may be made in any of a number of different ways, including the use of public data networks, such as the Internet, intranet, direct lines, wireless communications, etc.

In operation, customer locations 10 provide the central shipping controller 12 with demands for certain finished goods or parts. The central shipping controller 12 forms an optimized shipment plan and arranges for the shipment of the goods or parts to the customer locations 10 from one or more of the sources 16. In order to perform this process, the processor 14 is provided with computer readable media 18 that bears the instructions that cause the processor 14 to perform the methodology of the present invention.

In the following description of the auto-shipper process of the present invention, exemplary tables are provided for explanatory purposes. It should be clearly understood, however, that these are exemplary only for purposes of understanding, and do not limit the invention. The numerical values provided in the specific entries in the tables are also exemplary and provided merely for illustrative purposes.

The first step in embodiments of the present invention for auto shipping is a prioritization step in which all requests are ordered by certain parameters. In these embodiments, these parameters are part number, priority need and a comparison to the inventory available to ship. An exemplary table is provided below.

TABLE 1

| Part Number | Request | Inventory Available | % Need |
|---|---|---|---|
| 1 | 280 | 100 | 70% |
| 2 | 1500 | 700 | 50% |

As can be seen from this first table, there are two part numbers (1, 2). For part number 1, there is a request for 280 units (or parts). The inventory available for these parts is 100 units. The priority need (or percent need) is 70%. Similarly, for part number 2, a requested number of units is 1500, while the inventory available is 700. The percent need is 50%.

Following the part number prioritization step, as described above, the processor 14 drops into the detailed section of each line item within the part number prioritization where inventory is available. The prioritized list is generated by line item, which includes the total available inventory as well as the prioritization scheme per all locations that 10 to have a need for the part (identified by the part number) in question. Table 2, reproduced below, shows this information for a single part number and four different customer locations 10 (customer locations A, B, C, D).

TABLE 2
Part Number: 1 Inventory Avail: 100

| Location | Request | % Need |
|---|---|---|
| A | 100 | 100% |
| B | 80 | 80% |
| C | 60 | 60% |
| D | 40 | 40% |

Hence, for part number 1, the inventory available is 100 units, and customer location A requests 100 units and has a percent need given at 100%. The specifics for customer locations B, C, D may be read from this table as well.

Once the prioritization scheme has been set up, through the part number prioritization and the location prioritization steps, the auto shipping algorithm is performed by the processor 14 of the central shipping controller 12. The basis for the algorithm is to provide a volume-based fair share distribution of product available for all sites in need. The objective of the algorithm is to bring each site with demand for the same part number to the same percentage need and eventually back to 100%, which thereby fulfills the definition of balanced inventory.

The auto-shipper algorithm begins with a minimum lot size increment. The minimum lot size increment is defined within variable tables. In the example that is given below of the auto-shipper algorithm, the minimum lot size is set at 20. By using the lot size of 20, in essence, the auto-shipper algorithm of the present invention runs iterations whereby 20 parts are assigned to the highest priority location. The location prioritization table is then re-organized for new priorities, while the allocated part quantities become the basis for a shipment plan table.

The minimum quantity, or minimum lot size, is used to act as a catalyst for a revolving algorithm, as described below. In each step, the minimum quantity is first checked against the quantity in inventory (AFGI). If the available quantity of parts is greater than the minimum lot size, this first check is passed.

Second, the minimum lot size is subtracted from the request of the highest priority and set aside in a temporary shipping document (“temp ship document”). The requests from the customer locations 10 are then re-prioritized and run through the same scenario. Once the available inventory is no longer greater than minimum lot size, the loop exits and the temp ship document then proceeds through a sales order and shipping procedure, as will be described. An example of this iterative process is provided below. In this example, the minimum lot size is 20, although other values for the minimum lot size may be employed.

In the first pass through the process, the inventory (AFGI) of parts is equal to 100. Part number is considered to be part number 1 for purposes of this example. This can be seen in Table 3 below, in which location A has a request for 100 of the parts, location B has a request for 80 of the parts, location C has a request for 60 of the parts, and location D has a request for 40 of the parts. Priority percentages are provided in the tables for each of these different customer locations 10.

TABLE 3

| AFGI = 100 | | |
|---|---|---|
| PN 1 | | |
| Location | Request | Priority |
| A | 100 | 100% |
| B | 80 | 80% |
| C | 60 | 60% |
| D | 40 | 40% |

Temp Ship Document

| Location | Ship |
|---|---|
| A | 20 |

Since location A has the highest priority at 100%, the minimum lot size amount of 20 units of the part number 1 are assigned to location A in a temporary shipping document, as indicated. Hence, inventory AFGI now contains 80 units for distribution assignment. In a second pass, as indicated in Table 4 below, AFGI is now equal to 80. Customer location A has a reduced priority since it has already been assigned 20 units during the first pass. Location B now is considered to be the top priority since it has a priority percent of 80%. Location A is reduced to an 80% priority based upon the assignment during pass number 1. In pass 2, location B is considered to have the highest priority since it is tied in priority with location A, but was previously lower in the Table. The temp ship document now reflects location A and location B both having 20 units assigned to them for shipping.

TABLE 4

| AFGI = 80 | | |
|---|---|---|
| PN 1 | | |
| Location | Request | Priority |
| B | 80 | 80% |
| A | 80 | 80% |
| C | 60 | 60% |
| D | 40 | 40% |

Temp Ship Document

| Location | Ship |
|---|---|
| A | 20 |
| B | 20 |

In the third pass of the process, the inventory has been reduced to 60 (AFGI=60) and location B has now had its priority reduced to 60% since the minimum lot size amount of 20 units has been assigned to location B in pass number 2. In pass 3, location A now has the highest priority (80%) so that the next minimum lot size amount of 20 units is assigned to location A. Temp ship document reflects this assignment so that location A now has 40 units assigned to it while location B has 20 units assigned to it.

TABLE 5

| AFGI = 60 | | |
|---|---|---|
| PN 1 | | |
| Location | Request | Priority |
| A | 80 | 80% |
| C | 60 | 60% |
| B | 60 | 60% |
| D | 40 | 40% |

Temp Ship Document

| Location | Ship |
|---|---|
| A | 40 |
| B | 20 |

In pass 4, the number of units left in inventory is equal to 40 (AFGI=40). Location C has the highest priority (80%) among the 4 locations so that the minimum lot size amount of 20 units is assigned to location C. This is reflected in the temporary shipment document. This is shown in Table 6 below.

TABLE 6

| AFGI = 40 | | |
|---|---|---|
| PN 1 | | |
| Location | Request | Priority |
| C | 60 | 60% |
| B | 60 | 60% |
| A | 60 | 60% |
| D | 40 | 40% |

Temp Ship Document

| Location | Ship |
|---|---|
| A | 40 |
| B | 20 |
| C | 20 |

In pass number 5, the inventory remaining is 20 units (AFGI=20). The highest priority location is location B at this stage (tied with location A, but formerly lower in the table). Hence, location B is assigned a minimum lot size amount (20 units), as reflected in the temp ship document.

TABLE 7

| AFGI = 20 | | |
|---|---|---|
| PN 1 | | |
| Location | Request | Priority |
| B | 60 | 60% |
| A | 60 | 60% |
| D | 40 | 40% |
| C | 40 | 40% |

Temp Ship Document

| Location | Ship |
|---|---|
| A | 40 |
| B | 40 |
| C | 20 |

After completion of pass 5, the quantity available in inventory for part number 1 is less than the minimum lot size (0<20). As seen in the table below, AFGI is equal to 0. The system of the present invention, as embodied by the processor 14, now creates a sales order for each of the customer locations A, B, C that have a recommended ship and then cuts the ship papers accordingly.

TABLE 8

| AFGI = 0 | | |
|---|---|---|
| PN 1 | | |
| Location | Request | Priority |
| A | 60 | 60% |
| D | 40 | 40% |
| C | 40 | 40% |
| B | 40 | 40% |

Following the formation of the temp ship documents, such as that described in the example above, the auto-shipper algorithm forms a complete shipment plan, such as the exemplary shipment plan provided below.

TABLE 9

| | | Recommended | |
|---|---|---|---|
| Part Number | Location | Shipper | Plan Impact |
| 1 | A | 40 | 40% |
| 1 | B | 40 | 40% |
| 1 | C | 20 | 20% |
| 2 | A | 400 | 40% |
| 2 | B | 300 | 25% |

In the example shown above, part number 1 is to be shipped in the quantities and to the locations as shown in the earlier example. In addition, exemplary quantities of part number 2 and the locations for recommended ship amounts appear in this plan.

After the initial shipment plan has been created based upon the auto-shipper algorithm described above, a first lot sizing optimization pass is run. This comprises a pallet size pass and a volume based filter pass. The pallet size pass has two main functions. The first is to ensure the possibility of small shipments, while the second function is to ensure that higher volume shipments will ship in full pallets. Two variables are employed in the pallet size pass to determine the success or failure of this pass. The first variable is the threshold quantity that is the quantity at which multiples of shippers are required to be cut in full pallets. The other variable is the pallet quantity that is the quantity of drives that will make up a full pallet. Examples of how the pallet size pass is employed now follow. In a first example, assume that customer location A has a requirement that all shipments come in a specific lot size quantity. By setting the threshold quantity at 0 and the pallet quantity at 320, it is ensured that the only recommended shipper that may pass through the pallet size pass would be in multiples of 320. For example, if the recommended shipper is equal to 180, the auto-shipper algorithm will pass on a zero value. However, if the recommended shipper is equal to 360, the auto-shipper algorithm will pass on a value of 320.

In a second example of the pallet size pass, customer location B may take very small quantities and fall into an exception category, although the product would typically be shipped in full pallets. By setting a threshold quantity at 800 and the pallet quantity at 800, a recommended shipper of 320 would be allowed to pass through, but any shipper amount over 800 would be scaled down to multiples of 800. Thus, for a recommended shipper equal 320, this is allowed to pass as 320. A recommended shipper of 2500 would be passed on as 2400 (3×800).

The volume based filter pass uses two measurements that work in combination in order to maintain a balance that allows small shipments to low volume customers while maintaining an optimal shipper quantity to higher volume customers. In the example above, assume that the pallet pass had no impact on the shipment plan. The volume based filtered pass now takes two more variables into consideration. These variables are defined as the minimum shipment quantity, which defines the smallest shipper that may be cut for a specific part number/location. The other variable is the % impact minimum. This variable provides a percent threshold that if a shipment does not meet this requirement, the shipment will not be able to pass on to the next shipment plan phase. The % impact is calculated by dividing the recommended shipper into the target inventory for a part number/location. This variable provides the impact of the shipment. In embodiments of the invention, the shipper will pass if either variable is satisfied.

In a first example of the volume based filter pass, the minimum shipment quantity is equal to 320 and the % impact minimum is equal to 30%. For a recommended shipper equal 160, and a target equal to 400, the % impact is equal to 160/400=40%. Hence, the shipper will pass since it is greater than the % impact minimum of 30%, even though the recommended shipper is below the minimum shipment quantity.

In a second example, the minimum shipment quantity is equal to 320, the % impact is still equal to 30%. For a recommended shipper of 400, target of 4,000, the % impact is equal to 400/4,000=10%. Although the % impact is less than 30%, the shipper will still pass based on the recommended shipper being greater than the minimum shipment quantity of 320.

In a third example, with the minimum shipment quantity set to 320, and the % impact variable set to 30%, assume the recommended shipper is equal to 300, the target equal 3,000, so that the % impact is equal to 300/3,000=10%. In this example, the shipper will not pass the volume based filter pass since the result does not satisfy either of the volume-based criteria.

The above-described processes may be performed for a single source or factory to supply multiple customer locations. The present invention also provides certain embodiments in which a multiple-source shipper process is available. The multiple-source shipper process is similar to the single source/factory process described above, except that an algorithm is employed to decide how to split the source of product for filling demand without violating a number of merge and transit rules, lot quantities, etc.

The first step of the multi-source logic of the present invention is to create a balanced/supply demand picture for the purpose of running the multi-source logic. In this embodiment, the balanced supply/demand picture is created by balancing down demand to available supply. As an example, using the auto-ship impact algorithm, described earlier, supply and demand are balanced as follows.

TABLE 10
Supply 1000

| Org | Location | Supply |
|---|---|---|
| 1 | S1 | 500 |
| 2 | S2 | 500 |

Demand 1300

| Org | Location | Demand | % Need |
|---|---|---|---|
| 1 | D1 | 500 | 90 |
| 3 | D2 | 400 | 80 |
| 3 | D3 | 400 | 70 |

In order to simply the multi-source logic, the percent need algorithm decreases the total demand by location to an aggregate equal to the supply as follows:

Algorithm runs.

New demand (site allotment by percent need) minus 1,000.

TABLE 11

| Org | Location | Supply |
|---|---|---|
| 1 | D1 | 450 |
| 3 | D2 | 300 |
| 3 | D3 | 250 |

A geographic/local sales rule is provided to ensure that geographic and local sale shipments are prioritized above optimization. In this rule, a “try to logic” is invoked. In other words, if a product is not able to fit the geographic/local sales rule, the product still has the ability to ship. An example of this is provided below.

TABLE 12

| | | |
|---|---|---|
| Org | Location | Supply |

Supply 550

| | | |
|---|---|---|
| 1 | S1 | 50 |
| 2 | S2 | 500 |

Demand 550

| | | |
|---|---|---|
| 3 | D2 | 300 |
| 3 | D3 | 250 |

As can be seen between the original and the updated table, the 450 units of demand that existed in organization 1, attempted to ship from inventory available in organization 1. Since 500 units of the parts existed, 450 were used to make the shipment in full to organization 1, location S1, while 50 units remain for demand in the following multi-source passes.

Business rule filters are provided for the multi-source algorithm to make sure that specific company rules are complied with to follow due diligence in shipping best case point-to-point. These business rules may be defined based on geography, specific customer requirements, etc., in a similar fashion to the way that shipping rules are assigned.

The multi-shipper algorithm employed by the processor 14 of central shipping controller 12 is an iterative algorithm that takes a hand-off of supply and demand from the business rule segment and creates a set of all supply/demand scenarios using all possible combinations of fully giving available supply to a demand point in a matrix-type format as follows.

TABLE 13

| | S1 | S2 |
|---|---|---|
| D1 | 50 | 250 |
| D2 | | 250 |

After creating all possible combinations, the processor 14 runs a sum of squares on the matrix, with the highest sum of squares becoming the efficient shipment method. Upon completion of the multi-source algorithm, the shipment plan is available which shows a first pass plan for the part number in question. At this point, the multi-source pass shipment plan will merge with the standard auto-shipper rules at the pallet size pass as described earlier.

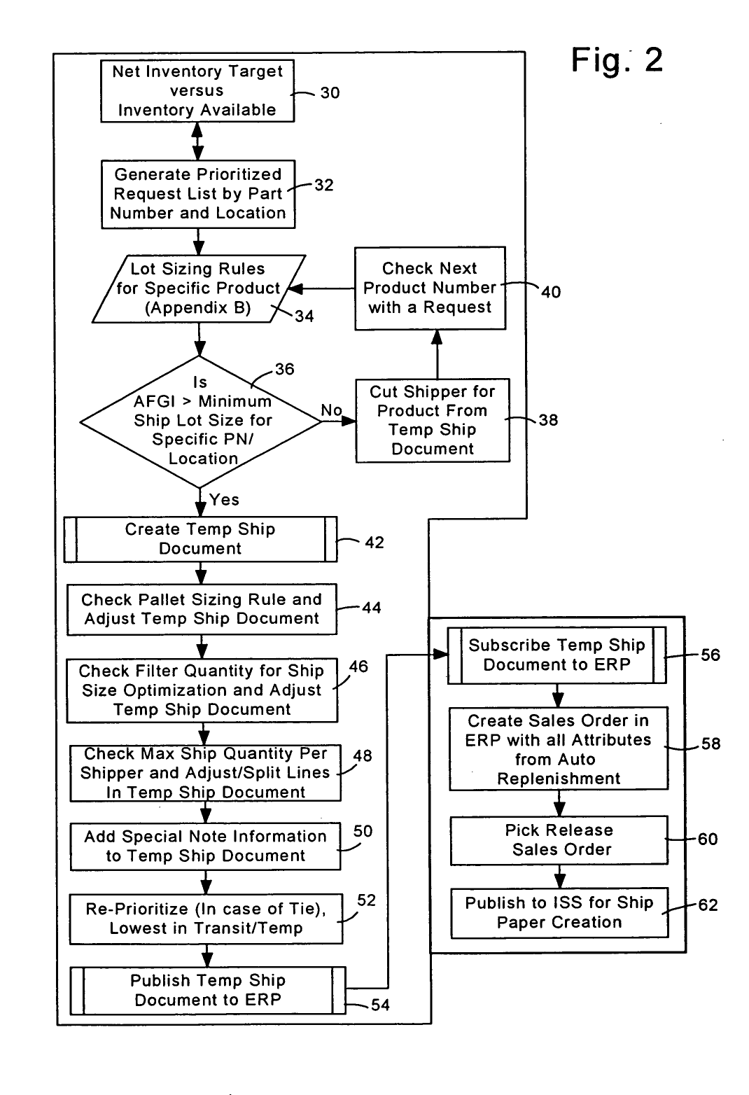

FIG. 2 shows a flowchart of an exemplary embodiment of the auto-shipper algorithm as performed by the processor 14 in accordance with instructions provided on computer readable medium 18. This flow is exemplary only, as other flows may be provided without departing from the scope of the present invention.

In step 30, the net inventory target versus inventory available is determined. A prioritized request list by part number and location is generated in step 32. Lot sizing rules for a specific product are applied in step 34. It is then determined in step 36 whether the inventory (AFGI) is greater than the minimum lot size for a specific part number/location. If not, the shipper is cut for the product from the temp ship document that has been generated, in step 38. The next product or part number with the request is then checked, in step 40. If the available inventory is greater than the minimum lot size for a specific part number/location as determined in step 36, a temp ship document is created in step 42. The pallet sizing rule is checked in step 44 and the temp ship document is adjusted. The filter quantity for the shipment size optimization is checked in step 46 and the temp ship document is again adjusted.

In step 48, the maximum ship quantity per shipper is checked and an adjustment/split of lines in the temp ship document is performed. Special note information is added to the temp ship document in step 50 as required. A re-prioritization of the locations is then made in step 52. In case of a tie, the lowest in the transit/temp ship document is provided with the highest priority. The temp ship document is published in step 54 to the ERP (What is ERP?). A temp ship document is then subscribed in ERP in step 56.

A sales order is created in ERP with all of the attributes from the auto replenishment in step 58. A pick release sales order is generated in step 60 and published to the ISS (What is ISS?) in order to create the ship paper, in step 62.

Other embodiments of the auto cut shipper algorithm may be provided without departing from the scope of the present invention. The auto cut shipper of the present invention, both method and system, provide for a volume-based fair share mode of distributing factory finished goods to a plurality of customer locations from either a single source or multiple-sources. The auto cut shipper may be performed as a batch process that runs scheduled jobs.

Although the present invention has been described and illustrated in detail, it is to be clearly understood that the same is by way of illustration and example only and is not to be taken by way of limitation, the scope of the present invention being limited only by the terms of the appended claims.

What is claimed is:

1. A computer-implemented method for distributing parts to customer locations in a volume-based fair share mode, comprising the steps:
prioritizing requests for parts from inventory;
prioritizing locations that have need for the parts; and
forming a shipment plan by iteratively: assigning a defined minimum size allotment of the parts to the location having the current highest priority; and re-assigning the priorities of the locations; until all of the parts from inventory have been assigned or no location needs more of the parts assigned.

2. The method of claim 1, further comprising defining the minimum size allotment.

3. The method of claim 2, wherein each location having a need for the parts from inventory has a percentage need for said parts, and the step of forming a shipment plan includes assigning the minimum size allotment to a highest priority location in each iteration and thereafter re-assigning the priorities such that each location having a need is driven to the same percentage need.

4. The method of claim 3, further comprising performing a pallet size pass on the shipment plan.

5. The method of claim 4, wherein the pallet size pass is based on a threshold quantity at which multiples of shippers are cut in full pallets.

6. The method of claim 5, wherein the pallet size pass is based on a pallet quantity that is a quantity of parts that constitutes a full pallet.

7. The method of claim 6, wherein each shipper that passes through the pallet size pass has a number of parts greater than the threshold quantity and equal to or less than the pallet quantity.

8. The method of claim 4, further comprising performing a volume based filter pass on the shipment plan.

9. The method of claim 8, wherein the volume based filter pass is based on a minimum shipment quantity defining a smallest amount of parts for a specific location or part type.

10. The method of claim 8, wherein the volume based filter pass is based on a percentage impact threshold that is a function of a recommended shipper and a target inventory for a specific location or part type.

11. The method of claim 8, wherein the parts are shipped from a single source.

12. The method of claim 8, wherein the parts are shipped from multiple sources, and further comprising determining splitting the source of the parts to fulfill the requests for parts from the locations.

13. The method of claim 12, wherein the determining includes forming a balanced supply/demand.

14. The method of claim 13, wherein the determining further includes geographic/local sales rules in which specified geographic and local sales shipments are prioritized over optimization of shipments.

15. The method of claim 14, wherein the determining further includes a business rule filtering in which specified business rules are prioritized over optimization of shipments.

16. The method of claim 15, further comprising creating a set of all supply demand scenarios with all possible combinations of fully providing available supply to a demand point in a matrix, and subsequently performing a sum of squares on the matrix, with the highest sum of squares forming a shipment plan.

17. A computer readable medium bearing programming instructions, which, when executed by a computer, cause the computer to determine distribution of parts from inventory to customer locations in a volume-based fair share mode according to the steps:
prioritizing requests for a part from inventory by the customer locations based on the part, a priority need for the part, and inventory available to ship;
prioritizing the customer locations that have a need for the part; and
forming a shipment plan by iteratively:
assigning a defined minimum size allotment of the parts to the customer location having a current highest priority; and
re-assigning the priorities of the customer locations.

18. The computer readable medium of claim 17, the media bearing further programming instructions to cause the computer to perform lot sizing optimization after the shipment plan is formed.

19. The computer readable medium of claim 18, the media bearing further programming instructions to cause the computer to split the source of the parts when there are multiple sources of the parts.

20. A system for determining distribution of goods to customer locations, comprising:
a processor that receives requests for parts to be delivered to customer locations; and
means for forming a shipment plan of the goods to the customer locations on a volume-based fair share basis.
